(19) United States
(12) Patent Application Publication
(10) Pub. No.: US 2007/0221136 A1
(43) Pub. Date: Sep. 27, 2007

(54) HANDBAG AND PET CARRIER COVERLET ACCESSORY

(76) Inventor: Marianne K. Buttner, Cincinnati, OH (US)

Correspondence Address: HASSE & NESBITT LLC, 8837 CHAPEL SQUARE DRIVE, SUITE C, CINCINNATI, OH, 45249, US

(21) Appl. No.: 11/756,969

(22) Filed: Jun. 1, 2007

Related U.S. Application Data
(63) Continuation-in-part of application No. 11/322,087, filed on Dec. 29, 2005.

(51) Int. Cl. A01K 1/03

(52) U.S. Cl. 119/497

(57) ABSTRACT

A “coverlet” accessory enables a pet owner to temporarily alter the aesthetic appearance of a pet carrier and associated handbag. The accessory is typically constructed from a unitary, or one-piece, fabric or other flexible panel having an inner-facing surface adapted for releasable attachment to an exterior surface of the pet carrier or handbag body, and a personalized decorative outer facing surface. One or more coverlets can be attached to various areas of any of a number of different conventional pet and handbag carrier styles, to enhance the aesthetic appearance thereof without interfering with the functionality of any existing structural features of the carrier or handbag.

### CROSS-REFERENCE TO RELATED APPLICATION

This application is a continuation-in-part of U.S. patent application Ser. No. 11/322,087, filed Dec. 29, 2005.

### FIELD OF THE INVENTION

The present invention relates generally to decorative handbags having a coordinated design with associated pet carriers. More particularly, the invention relates to removable and interchangeable decorative coverlet accessories for such handbags and pet carriers.

### BACKGROUND OF THE INVENTION

Pet carriers are functional bags and similar pieces, typically designed for transporting cats, dogs and other relatively small animals, in a comfortable manner for both the pet and the pet owner. Such bags are particularly useful for transporting small pets, for example in an automobile, train, airplane, or other vehicle, where it is not possible or practical to hold the animal. Pet carriers typically include padded bottoms, which may be removable, elasticized safety collars, side mesh paneling for ventilation and viewing, and a flap or other closure to secure the pet inside of the carrier. Carriers may also include additional features such as a zippered window, to enable the animal to stick out its head, exterior auxiliary pockets to hold, for example, grooming items, and other exterior structures. In recent years more expensive fashionable pet carriers have become increasingly popular, designed to give the fashion conscious pet owner a viable alternative to the pet carrier of old. A drawback of such pet carriers is that that, unless extraordinary wealthy, most pet owners can only afford to purchase a single luxury pet carrier and, therefore, are stuck with a single design.

Accordingly, it would be highly desirable to provide a luxury pet carrier having the flexibility to enable a pet owner to change or alter the aesthetic appearance, or “look,” of the carrier without requiring the purchase of a completely new carrier. In that regard, it would be desirable to provide an accessory assembly that could be used in conjunction with virtually any commercially available pet carrier, to enable the pet owner to temporarily alter the look of a pet carrier by providing an inexpensive releasably attachable exterior surface accessory. Moreover, it would be desirable to provide a decorative accessory assembly for a handbag, such as a purse, briefcase, or luggage bag, having a coordinated design with the assembly for the pet carrier.

### SUMMARY OF THE INVENTION

The invention is directed to auxiliary accessory items for enabling a pet owner to temporarily alter the aesthetic appearance of a pet carrier and an associated handbag. Each accessory is generally comprised of a panel, such as a fabric, leather or metal panel, having an inner-facing surface adapted for releasable attachment to an exterior surface of the body of the pet carrier or the handbag, and a personalized decorative outer facing surface.

In one embodiment, the invention relates to a system comprising (a) a coverlet assembly constructed for releasable attachment to the exterior of a handbag, the handbag having a body including a front side, a rear side, an upper side and a bottom side, the coverlet assembly comprising a unitary panel having opposite first and second ends, an outer-facing surface and an inner-facing surface; and a fastening system to affix the inner-facing surface of said panel to the exterior of the body of said handbag; and (b) a coverlet assembly constructed for releasable attachment to the exterior of a pet carrier, the pet carrier having a body including a front side, a rear side, an upper side and a bottom side, the coverlet assembly comprising a unitary panel having opposite first and second ends, an outer-facing surface and an inner-facing surface; and a fastening system to affix to the inner-facing surface of said panel to the exterior of the body of said pet carrier.

In another embodiment, the invention relates to a system comprising (a) a handbag and coverlet combination, comprising a handbag body having a front, rear, left, right, bottom and top sides together defining an interior space for receiving items placed in the handbag; opening means for enabling ingress and egress into and out of said interior space; a decorative panel having a perimeter edge separating an inner-facing surface and an outer-facing surface; and means for enabling releasable attachment of the inner-facing surface of said decorative panel to an exterior surface of at least one of said sides of said handbag body, said attachment means enabling attachment of said decorative panel to said handbag body without disrupting opening and closing of said opening means; and (b) a pet carrier and coverlet combination, comprising a pet carrier body having a front, rear, left, right, bottom and top sides together defining an interior space for receiving an animal; carrying means attached to the pet carrier body; opening means for enabling ingress and egress of said animal into and out of said interior space; a decorative panel having a perimeter edge separating an inner-facing surface and an outer-facing surface; and means for enabling releasable attachment of the inner-facing surface of said decorative panel to an exterior surface of at least one of said sides of said pet carrier body, said attachment means enabling attachment of said decorative panel to said carrier body without disrupting opening and closing of said opening means.

In one aspect of the invention, the coverlets have a construction lending to efficient, cost-effective manufacture.

In another aspect of the invention, the coverlets have a construction that is highly customizable.

In yet another aspect of the invention, the coverlets have a construction facilitating their attachment and removal from the pet carrier or handbag body, without disruption of, among other things, opening and closing of the body and access to the interior thereof and any exterior pockets and other structure thereon.

In still another aspect of the invention, the coverlet construction has an inherent flexibility enabling attachment to any of a host of different commercially available pet carrier and handbag designs.

These and other aspects, features, and advantages of the present invention will become more readily apparent from the attached drawings and the detailed description of the various embodiments, which follow.

### BRIEF DESCRIPTION OF THE DRAWINGS

The embodiments of the invention will hereinafter be described in conjunction with the appended drawings provided to illustrate and not to limit the invention, where like designations denote like elements, and in which:

FIG. 1 is a perspective view of a coverlet in accordance with the invention;

FIG. 2 is a perspective view of a coverlet in accordance with another embodiment;

FIG. 3 is a perspective view of a coverlet of the type shown in FIG. 1 attached to a first type of pet carrier;

FIG. 4 is a perspective view of a coverlet of the type shown in FIG. 1 attached to another type of pet carrier;

FIG. 5 is a perspective view of other coverlets of the invention shown attached to a wheeled pet carrier;

FIG. 6 is an exploded perspective view of a coverlet of the invention configured for releasable attachment to yet another type of pet carrier; and

FIG. 7 is an exploded perspective view of a coverlet of the invention configured for releasable attachment to a purse, and having a coordinated design with the pet carriers of FIGS. 4 and 6.

### DETAILED DESCRIPTION OF THE INVENTION

Shown throughout the drawings, the invention is generally directed to design accessory items, each of which is alternatively referred to herein as a “coverlet assembly” or a “coverlet”, for enabling a pet owner to temporarily alter the aesthetic appearance of a pet carrier and an associated handbag. Each accessory is typically constructed from a unitary, or one-piece, panel having an inner-facing surface adapted for releasable attachment to an exterior surface of the body of the pet carrier or the associated handbag, and a personalized decorative outer facing surface. One or more coverlets can be attached to various areas of any of a number of different conventional pet carrier and handbag styles, to enhance the aesthetic appearance of the carrier and handbag, without interfering with the functionality of any existing structural features thereof.

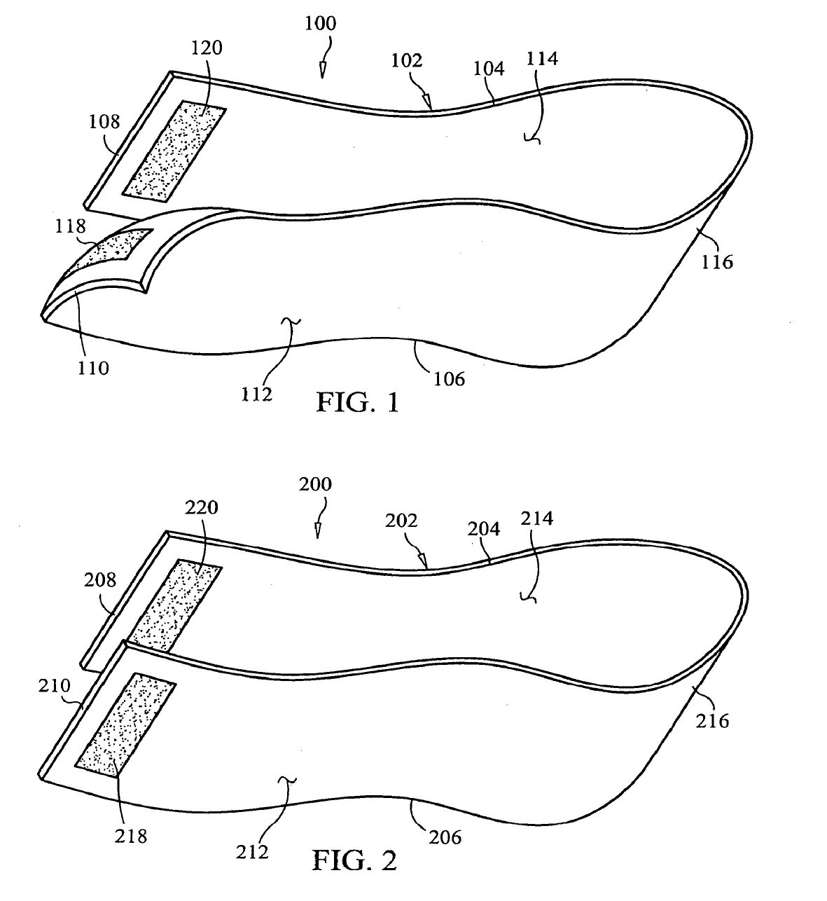

Referring initially to FIG. 1, in one embodiment, a coverlet, shown generally as reference numeral 100, is fabricated from a one-piece fabric panel 102. The fabric panel 102 may have a generally rectangular shape defined by edges 104, 106, 108 and 110. The fabric panel has an outer-facing surface 112 and an inner-facing surface 114. As used herein, the term “inner facing” is means that this surface engages, or faces, the pet carrier or handbag body (not shown in FIG. 1) when the coverlet is attached to the carrier or handbag. In one aspect of the invention, hook portions 118, 120 of a conventional hook-pile type fastening system are provided permanently secured to the inner-facing surface 114 proximate to the opposite end edges 108 and 110 of the fabric panel. The function of these areas and the relevance of their positioning will be further described below.

Referring briefly to FIG. 2, in an alternate aspect of the invention, a coverlet, shown generally as reference numeral 200, also fabricated from a one-piece fabric panel 202 is provided. Fabric panel 202 may also have a generally rectangular shape defined by edges 204, 206, 208 and 210. Likewise, the fabric panel has an outer-facing surface 212 and an inner-facing surface 214. However, in this aspect of the invention, a hook portion 218 of a hook-pile fastening system is provided permanently secured to the outer-facing surface 212 proximate to end edge 210, while a corresponding pile portion 220 of the hook-pile fastening system is provided permanently secured to the inner-facing surface 214 proximate to fabric panel end edge 208. During attachment, middle portion 216 of panel 202 would be positioned proximate to a bottom side of a carrier or handbag, and the end of the panel adjacent edge 208 would overlap the end of the panel adjacent edge 210 to enable temporary fastening of hook and pile portions, 218 and 220, to each other. Alternatively, the location of the hook portion 218 and pile portion 220 may be reversed so that hook portion 218 is adjacent edge 208 and pile portion 220 is adjacent edge 210. Although not illustrated attached to a pet carrier or handbag, it will be understood by those skilled in the art that this configuration could be used to provide a coverlet, completely surrounding and hugging a pet carrier or handbag body, where the pet carrier or handbag has a side panel opening, or other such opening means with which this configuration would not interfere.

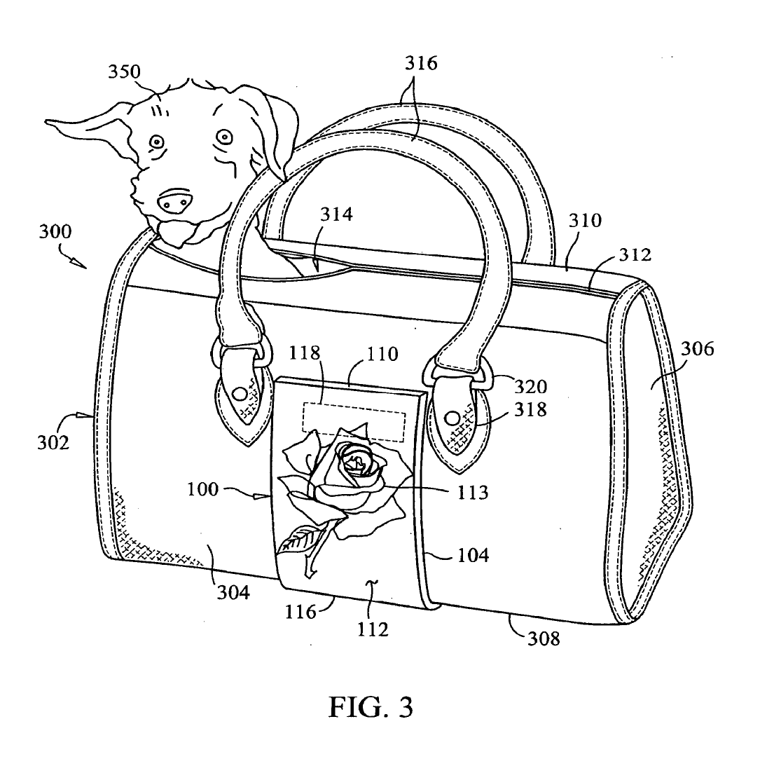

Referring now particularly to FIG. 3, an application of a coverlet such as coverlet 100 to one conventional type of pet carrier bag 300 is shown. The conventional pet carrier bag has a body 302 generally defined by front and rear sides 304, left and right sides 306, a bottom side 308 and an upper side 310. A zipper 312 or similar opening means traverses the upper side 310 to enable opening of the upper side to secure a pet 350 within an interior space 314 of the carrier 300. Typically, handle straps 316 are provided secured to the front and rear sides 304 of the carrier body 302, for example, by a ring 320 and snap loop 318 mechanism. Coverlet 100 is extended between the left and right carrier sides 306 such that the middle portion 116 of the fabric panel coincides with the bottom side 308 of the carrier body 302 when the coverlet is attached. Hook portion 118 adjacent end edge 110 of fabric panel 102 cooperates with a corresponding pile portion (hidden in FIG. 3) provided permanently secured to the exterior surface of the side 304 of the carrier body 302. The hook portion 120 at the opposite end edge 108 of fabric panel 102 cooperates with another pile portion (not shown) on the exterior surface of the other side of the carrier body 302. In another embodiment, the exterior surface of the carrier body 302 is made of a woven fabric and the hook portions 118 and 120 are configured to releasably attach directly to the exterior surface of the carrier body. The use of a hook-pile fastening system facilitates easy attachment and removal of the coverlet. However, as will be apparent to those skilled in the art, alternative temporary attachment mechanisms, such as conventional mechanical snaps, buttons, latches, zippers, and magnetized elements or magnets, are considered to be within the scope of the invention. As shown in FIG. 3, when the coverlet is attached, the outer-facing surface 112 is exposed. Significantly, the outer surface 112 is decorative. This may be achieved by providing a design printed, sewn, embossed, or otherwise disposed directly on outer surface 112. Additionally, or in the alternative, one or more decorative or ornate structural components, such as component 113, which may include cloth, leather, metal, glass, ceramic, gemstones, strung beads and/or jewelry findings, may be provided attached to outer surface 112 of coverlet 100, as desired.

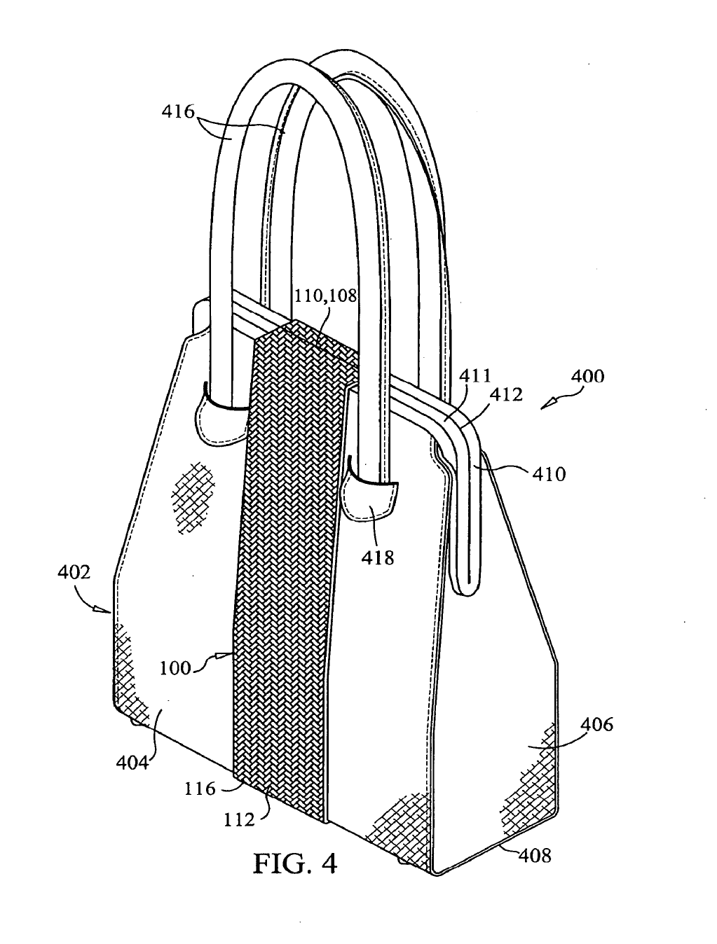

Referring briefly to FIG. 4, a coverlet 100 may be attached to a pet carrier 400 such that the fabric panel extends completely about the pet carrier body 402. As shown, the pet carrier body 402 has a conventional structure, generally defined by front and rear sides 404, left and right sides 406, bottom side 408 and a top portion 410. In this case the top side 410 is primarily comprised of a pair of cooperating rigid members, 411 and 412, extending downward along the left and right sides 406, which are capable of being biased to open or close the carrier, in accordance with a typical pet carrier structure. In this embodiment of the invention, hook portions (not shown) on the inner facing surface 114 of the fabric panel 102 are releasably attachable to cooperating pile portions (not shown), of a hook-pile system, secured to cooperating rigid members 411 and 412, or to the interior surface of pet carrier 400. For example, pile portions may be sewn or adhesively attached, as is well understood in the art. The end edges, 108 and 110, of coverlet 100 abut one another when the top portion 410 is in a closed state. In FIG. 4, the coverlet 100 is shown having a rectangular shape having a width enabling the fabric panel to be extended between the pet carrier handle portions 416 and handle attachment portions 418. However, it should be understood that the invention is not intended to be so limited. That is, although it is important that the coverlet does not interfere with existing pet carrier structural and functional features, it may be provided having any of a variety of different geometries, shapes and sizes.

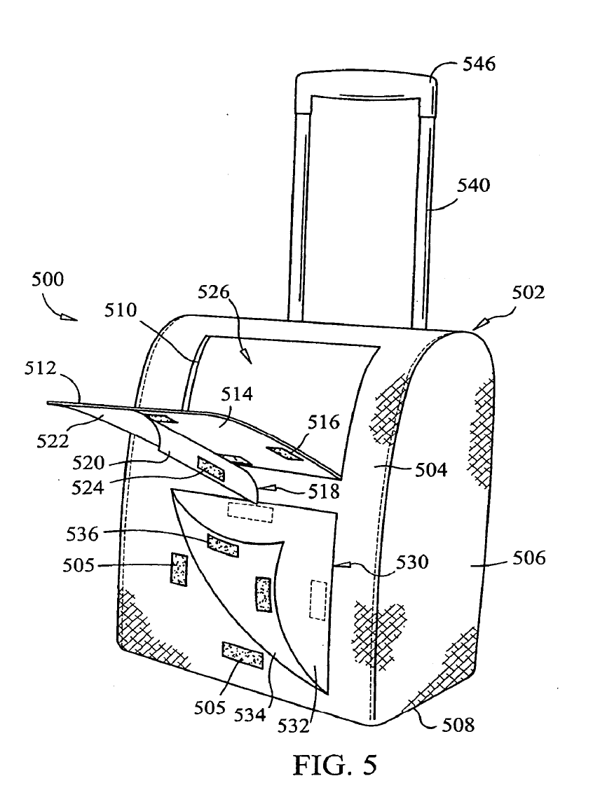

Referring now to FIG. 5, in another aspect of the invention, the coverlets are provided for use with a conventional wheeled (not shown) pet carrier, shown generally as reference numeral 500. This type of pet carrier typically includes a carrier body 502 generally defined by an upside-down U-shaped carrier panel 504, left and right side panels 506, and a bottom panel 508. An opening 510 is provided, typically in panel 504, for securing a pet animal (not shown) within an interior space 526. A door panel 512 is provided cooperating with the opening 510 in typical fashion. A handle 546 is typically provided attached to retractable arms 540. The outer surface 514 of the door panel 512 is provided having a plurality of spaced apart pile portions 516 of a hook-pile type fastening system. A coverlet 518, having a size and shape complementary to the door panel 512, is fabricated from a fabric panel having a decorative outer-facing surface 522 and an inner-facing surface 520 having a plurality of hook portions 524 for releasable engagement with the respective pile portions 516. In addition to coverlet 518, or as an alternative, one or more coverlets 530 may be provided for releasable attachment to the outer surface of carrier panel 504. In this case, a plurality of pile portions 505 are provided permanently secured to the outer surface of the carrier panel 504 for releasable engagement with hook portions 536 provided affixed to inner-facing surface 534 of the coverlet 530. Outer facing surface 532 may be provided having an integral surface design and/or ornamental structure or texture, as was previously described above herein with respect to FIG. 3.

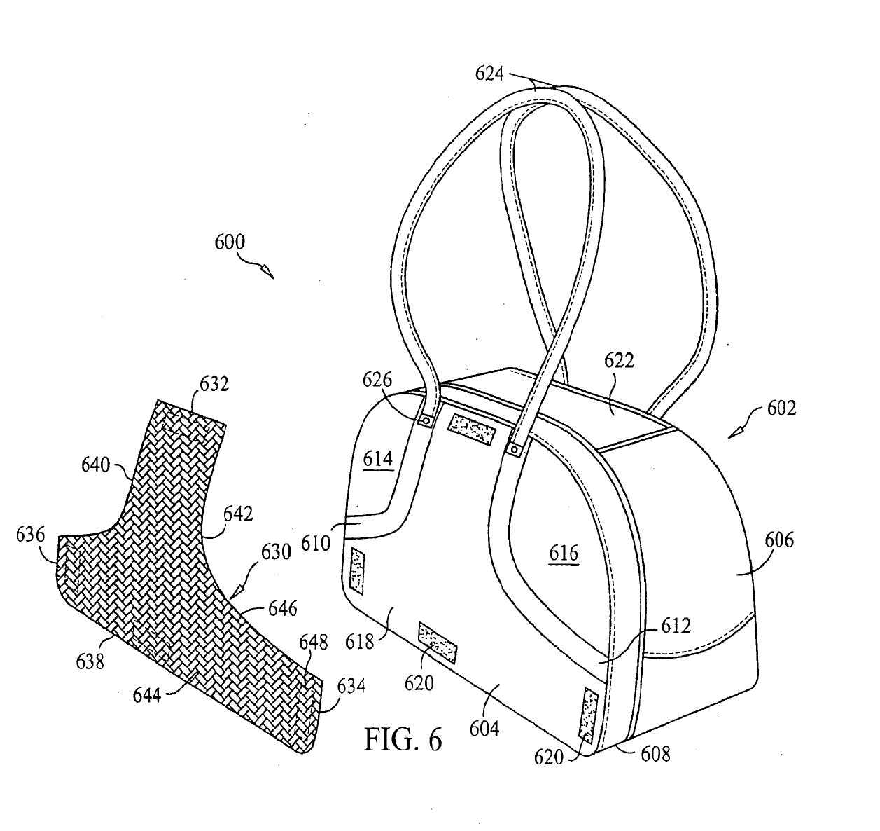

As stated above, the coverlets of the present invention can be provided having a virtually unlimited variety of geometries. Referring to FIG. 6, a pet carrier coverlet system is provided. Coverlet 630 may be fabricated from a fabric panel 642 having a geometry defined by a combination of linear and actuate, or curved, side edges 632, 634, 636, 638, 640 and 642. The fabric panel 642 has an outer-facing decorative surface 644 and an inner-facing surface 646 having a plurality of hook portions 648 of a hook-pile fastening system permanently attached thereto. In this case, the coverlet is particularly configured for releasable attachment to a conventional pet carrier 602 having front and rear side panels 604 and left and right side panels 606 curving upward toward an upper side panel 622, which may or may not be constructed as a panel door. Strap handles 624 are secured by strap attachments 626 to a pair of handle strap attachment strips, 610 and 612, respectively. The attachment strips 610 and 612 divide the outer surface of pet carrier side 604 into a left surface area 614, a right surface area 616, and a main central surface area 618. In this case, the coverlet panel is sized and shaped to conform to central surface area 618, such that the hook portions 648 of the coverlet panel co-align with the respective pile portions 620.

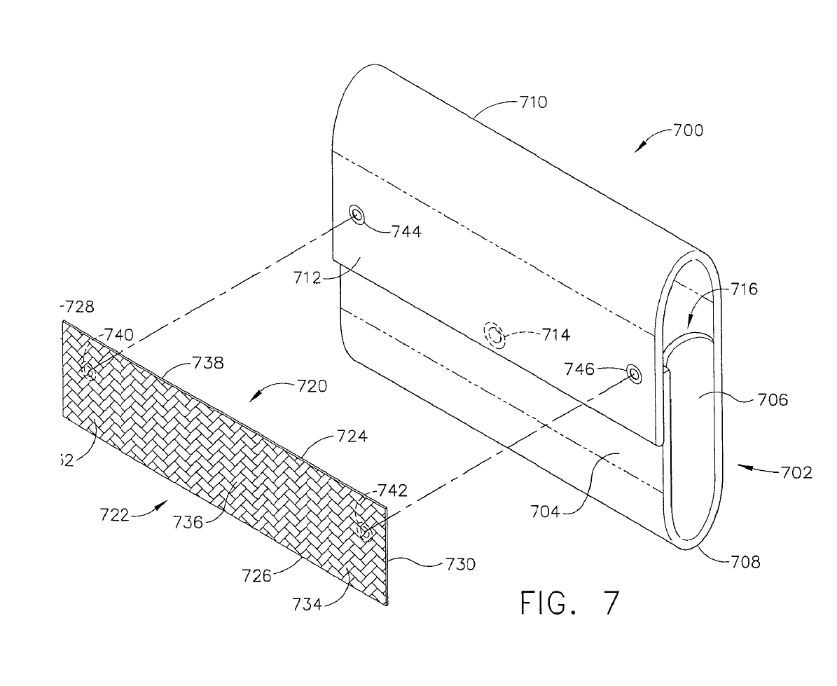

FIG. 7 illustrates the application of a coverlet, such as coverlet 720, to a handbag, such as purse 700. The purse has a body 702 generally defined by front and rear sides 704, left and right sides 706, a bottom side 708 and an upper side 710. A flap 712 extends from the rear side over the top and to the front side of the purse. A mechanical snap portion 714 located on the interior side of the front portion of the flap connects with a corresponding snap portion on the exterior of the front side 704 to enable closure of the flap to secure items within an interior space 716 of the purse. Of course, the purse may have other shapes, sizes, and designs, and other opening/closure means, such as a zipper, for enabling ingress and egress into and out of the interior space. The purse may also have one or more handle straps secured to the sides of the body, for example, by a ring and snap loop mechanism.

Coverlet 720 is fabricated from a one-piece fabric panel 722, which has a rectangular shape defined by edges 724, 726, 728 and 730, which define opposite first end 732 and second end 734. The fabric panel has an outer-facing surface 736 and an inner-facing surface 738, and is sized such that the opposite ends 732 and 734 are both attachable to the body of the purse. Coverlet 720 extends between the left and right sides 706 of the purse and is releasably attached to the distal portion of flap 712 by mechanical snap portions 740 and 742, which are permanently secured to the inner-facing surface of the coverlet and connect with the corresponding snap portions 744 and 746 permanently secured to the exterior surface of the flap. This illustrates one method of releasably attaching the inner-facing surface of the coverlet panel to an exterior surface of the body of the purse, without disrupting opening and closing of the purse and access to its interior space. As will be apparent to those skilled in the art, alternative releasable fastening systems, such as other mechanical snaps, buttons, latches, hook and pile fastners, zippers, and magnetized elements or magnets, may be used to affix the inner-facing surface of the coverlet to the exterior of the body of the purse.

As shown in FIG. 7, when the coverlet is attached, the outer-facing surface 736 is exposed. The outer surface typically is decorative, and may have a design that is coordinated with that of the outer surface of the coverlet attached to the pet carrier herein. The coverlet 720 may have a design printed, sewn, embossed, or otherwise disposed directly on its outer surface. Additionally, or in the alternative, one or more decorative or ornate structural components, which may include cloth, leather, metal, glass, ceramic, gemstones, strung beads and/or jewelry findings, may be attached to the outer surface of the coverlet or to trim attached thereto, as desired. Typically, each coverlet panel has a decorative component that is permanently affixed to the outer-facing surface thereof. In FIG. 7, the outer-facing surface of the coverlet panel has a design and decorative component that is coordinated with the coverlet panel attached to the pet carrier in FIGS. 4 and 6.

While various embodiments of the invention have been described above, it will be recognized and understood that modifications can be made in the invention and the appended claims are intended to cover all such modifications which may fall within the spirit and scope of the invention. For instance, while the coverlets typically are made from fabric panels, it is to be understood that any alternative panel material may be used, as long as the panel material has adequate flexibility to conform to bending, twisting and other distortion that the side panel may encounter when attached to the pet carriers and handbags of the invention. For example, the panels may comprise leather, or pieces of metal, glass, plastic, or combinations thereof, with or without fabric backing or components. It should also be apparent to those skilled in the art that, while the coverlets of the present invention are particularly designed for use with pet carriers, the coverlets could be utilized to accessorize other types of carriers, including, for example, conventional luggage and handbags, including purses and briefcases.

What is claimed is:

1. A system comprising:
(a) a coverlet assembly constructed for releasable attachment to the exterior of a handbag, the handbag having a body including a front side, a rear side, an upper side and a bottom side, the coverlet assembly comprising:
a unitary panel having opposite first and second ends, an outer-facing surface and an inner-facing surface; and
a fastening system to affix the inner-facing surface of said panel to the exterior of the body of said handbag; and
(b) a coverlet assembly constructed for releasable attachment to the exterior of a pet carrier, the pet carrier having a body including a front side, a rear side, an upper side and a bottom side, the coverlet assembly comprising:
a unitary panel having opposite first and second ends, an outer-facing surface and an inner-facing surface; and
a fastening system to affix to the inner-facing surface of said panel to the exterior of the body of said pet carrier

2. A system as recited in claim 1, wherein the coverlet assembly for attachment to the pet carrier comprises a hook-pile fastening system, and the panel is sized such that the opposite ends of the panel are both attachable to the carrier body, such that the panel is maintained in a taut condition, extending from the upper side, completely around the front, bottom, and rear sides.

3. A system as recited in claim 1, wherein the coverlet assembly for attachment to the handbag comprises a mechanical snap fastening system, and the panel is sized such that the opposite ends of the panel are both attachable to the handbag body.

4. A system as recited in claim 1, wherein each panel has a decorative component permanently affixed to the outer-facing surface thereof.

5. A system as recited in claim 1, wherein the coverlet assembly for attachment to the pet carrier comprises:
a unitary generally rectangular-shaped fabric panel having opposite first and second ends, an outer-facing surface and an inner-facing surface; and
a hook portion of a hook-pile fastening system permanently affixed to the inner-facing surface of said fabric panel proximate to the first end; and
a pile portion of said hook-pile fastening system permanently affixed to the outer-facing surface of said fabric panel proximate to the second end,
wherein the generally rectangular-shaped fabric panel is particularly sized such that when the panel is extended completely around the front, rear and bottom sides of the pet carrier body, the hook and file portions engage each other to maintain the fabric panel in a taut condition and against the pet carrier exterior.

6. A system as recited in claim 5, wherein said fabric panel has a decorative component permanently affixed to the outer-facing surface thereof.

7. A system as recited in claim 6, wherein the coverlet assembly for attachment to the handbag comprises a mechanical snap fastening system, and the panel is sized such that the opposite ends of the panel are both attachable to the handbag body.

8. A system as recited in claim 7, wherein the pet carrier body includes at least one carrying strap attachment strip affixed to its outer surface, the strip dividing the outer surface into left, right and central surface areas, the coverlet comprising:
a fabric panel having a perimeter edge, an inner-facing surface and an outer-facing surface, the panel having a shape conforming to the central surface area of the pet carrier body;
the outer-facing surface of the fabric panel having a decorative, aesthetically-pleasing appearance;
the inner-facing surface of the fabric panel having a plurality of hook portions of a hook-pile fastening system permanently affixed thereto adjacent to said perimeter edge;
a plurality of pile portions of a hook-pile fastening system permanently affixed to the pet carrier body outer surface along the perimeter of said central surface area,
wherein the hook portions of the fabric panel corresponding directly to the pile portions of the pet carrier body to enable releasable attachment of the fabric panel, in a taut condition, to the central surface area of the pet carrier body.

9. A coverlet as recited in claim 8, wherein the coverlet assembly for attachment to the handbag comprises a fabric panel having a decorative component permanently affixed to the outer-facing surface thereof that is coordinated with the decorative component of the fabric panel of the coverlet assembly for the attachment to the pet carrier.

10. A system comprising:
(a) a handbag and coverlet combination, comprising:
a handbag body having a front, rear, left, right, bottom and top sides together defining an interior space for receiving items placed in the handbag;
opening means for enabling ingress and egress into and out of said interior space;
a decorative panel having a perimeter edge separating an inner-facing surface and an outer-facing surface; and
means for enabling releasable attachment of the inner-facing surface of said decorative panel to an exterior surface of at least one of said sides of said handbag body, said attachment means enabling attachment of said decorative panel to said handbag body without disrupting opening and closing of said opening means; and
(b) a pet carrier and coverlet combination, comprising:
a pet carrier body having a front, rear, left, right, bottom and top sides together defining an interior space for receiving an animal;
carrying means attached to the pet carrier body;
opening means for enabling ingress and egress of said animal into and out of said interior space;
a decorative panel having a perimeter edge separating an inner-facing surface and an outer-facing surface; and
means for enabling releasable attachment of the inner-facing surface of said decorative panel to an exterior surface of at least one of said sides of said pet carrier body, said attachment means enabling attachment of said decorative panel to said carrier body without disrupting opening and closing of said opening means.

11. A system as recited in claim 10, wherein said opening means of said pet carrier further comprises a zipper extending at least partially across the top side of the carrier body.

12. A system as recited in claim 11, wherein said decorative panel of said pet carrier extends completely around the front, rear, bottom and top sides of the carrier body, without disrupting opening and closing of said zipper.

13. A system as recited in claim 10, wherein said opening means of said pet carrier further comprises a door panel provided in at least one of the sides of the pet carrier body.

14. A system as recited in claim 10, wherein the coverlet assembly for attachment to the pet carrier comprises a hook-pile fastening system, and the panel is sized such that the opposite ends of the panel are both attachable to the carrier body, such that the panel is maintained in a taut condition, extending from the upper side, completely around the front, bottom, and rear sides.

15. A system as recited in claim 10, wherein the coverlet assembly for attachment to the handbag comprises a mechanical snap fastening system, and the panel is sized such that the opposite ends of the panel are both attachable to the handbag body.

16. A system as recited in claim 15, wherein the coverlet assembly for attachment to the pet carrier comprises a hook-pile fastening system, and the panel is sized such that the opposite ends of the panel are both attachable to the carrier body, such that the panel is maintained in a taut condition, extending from the upper side, completely around the front, bottom, and rear sides.

17. A system as recited in claim 10, wherein each decorative panel has a decorative component permanently affixed to the outer-facing surface thereof.

18. A system as recited in claim 17, wherein each decorative panel has a coordinated design.

19. A system as recited in claim 18, wherein each decorative panel is made of fabric.

20. A system as recited in claim 16, wherein each decorative panel has a decorative component permanently affixed to the outer-facing surface thereof.
